(19) United States
(12) Patent Application Publication
(10) Pub. No.: US 2015/0116799 A1
(43) Pub. Date: Apr. 30, 2015

(54) IMAGE PROCESSING APPARATUS AND METHOD OF ASSEMBLING THE SAME

(71) Applicant: ALPS ELECTRIC CO., LTD, Tokyo (JP)

(72) Inventor: Yoshihiro Someno, Miyagi-ken (JP)

(21) Appl. No.: 14/524,399

(22) Filed: Oct. 27, 2014

(30) Foreign Application Priority Data
Oct. 31, 2013 (JP) 2013-226773

(51) Int. Cl. G03H 1/22

(52) U.S. Cl. CPC G03H 1/2202; G03H 1/2294
USPC 359/9; 29/595

(57) ABSTRACT

A reddish collimated beam and a greenish collimated beam respectively emitted from one and another light emitters are separately radiated to different conversion regions of a phase modulation array. In the phase modulation array, phases of components of light are converted through a plurality of pixels, thereby obtaining a modulated beam that is an interfered beam. An image of the modulated beam is formed on a screen to generate a holographic image. The one light emitter and the other light emitter are each configured as a separate block, stacked one on top of another on a reference base, and separately positioned and secured.

### CLAIM OF PRIORITY

This application claims benefit of priority to Japanese Patent Application No. 2013-226773 filed on Oct. 31, 2013, which is hereby incorporated by reference in its entirety.

### BACKGROUND

1. Field of the Disclosure

The present disclosure relates to an image processing apparatus, which can generate a holographic image by using a laser light source, and a method of assembling the image processing apparatus.

2. Description of the Related Art

Japanese Unexamined Patent Application Publication No. 2002-133708 describes an optical apparatus using a hologram used as, for example, an optical pickup apparatus that reads data from a recording medium such as an optical disc. In the optical pickup apparatus described in Japanese Unexamined Patent Application Publication No. 2002-133708, a holographic element is disposed in front of an optical unit, which includes a light emitting element and a light receiving element, a collimating lens is disposed in front of the holographic element, and a collimated beam is emitted toward an objective lens.

In this optical pickup apparatus, the collimating lens is supported by a movement mechanism such that the collimating lens is movable in an optical axis direction. Means for detecting parallel light is provided in an optical path. The collimating lens is moved in the optical axis direction in accordance with a signal from the means for detecting parallel light. Thus, the light beam having passed through the holographic element can be maintained as the collimated beam.

As described in Japanese Unexamined Patent Application Publication No. 2002-133708, in an optical apparatus using a holographic element, it is required that a highly accurate collimated beam be constantly emitted by using a collimating lens. However, in a method in which the collimating lens is constantly moved in the optical axis direction for correction, means for detecting a collimated beam and a movement mechanism that moves the collimating lens are required. This makes the apparatus complex.

### SUMMARY

An image processing apparatus includes a laser unit, a collimating lens that converts a laser beam emitted from the laser unit into a collimated beam, a phase modulation array that modulates a phase of the collimated beam to generate a holographic image, and a positioning block. The laser unit is positioned at and secured to the positioning block. The positioning block has therein an optical path that allows the laser beam emitted from the laser unit to pass therethrough. A position of the collimating lens in an optical axis direction is adjusted and the collimating lens is secured in the optical path.

In the image processing apparatus according to the first aspect of the present invention, the laser unit and the collimating lens are secured to the positioning block with the positions of the laser unit and the collimating lens relative to each other highly accurately determined. Thus, the laser beam emitted from the laser unit can be constantly sent out as a highly accurate collimated beam. This facilitates generation of an accurate holographic image. Furthermore, parts where adjustment is required can be minimized in an optical path ahead of the collimating lens.

According to a second aspect, a method of assembling an image processing apparatus, the image processing apparatus including a laser unit, a collimating lens that converts a laser beam emitted from the laser unit into a collimated beam, a phase modulation array that modulates a phase of the collimated beam to generate a holographic image, and a positioning block, includes a step of adjusting a position of the laser unit relative to the positioning block and securing the laser unit and a step of adjusting a position of the collimating lens in an optical axis direction and securing the collimating lens in an optical path formed in the positioning block.

### BRIEF DESCRIPTION OF THE DRAWINGS

FIG. 1 is an explanatory view illustrating an example of an image processing apparatus according to an embodiment of the present invention installed in a vehicle;

FIG. 2 is an explanatory view illustrating an example of a display image formed by the image processing apparatus;

FIG. 3 is an exploded perspective view of the image processing apparatus according to the embodiment of the present invention;

FIG. 4 is a plan view illustrating arrangement of main components of the image processing apparatus according to the embodiment of the present invention;

FIG. 5 is a perspective view of part of the structure of a phase modulation unit seen in an arrow V direction in FIG. 4;

FIG. 6 is an exploded perspective view for explaining assembly and adjustment structure of the phase modulation unit illustrated in FIG. 5;

FIG. 7 is an enlarged exploded perspective view of an attachment and adjustment structure for a laser unit in a light emitter;

FIG. 8 is an enlarged plan view of part of the phase modulation unit for explaining optical paths;

FIG. 9 is a view seen in a IX direction in FIG. 8;

FIG. 10 is an exploded perspective view of a tilt adjustment mechanism for a light sending mirror; and

FIG. 11 is a perspective view of part of the structure of a holographic imaging unit seen in an arrow XI direction in FIG. 4.

### DESCRIPTION OF THE EXEMPLARY EMBODIMENTS

### On-Vehicle Structure

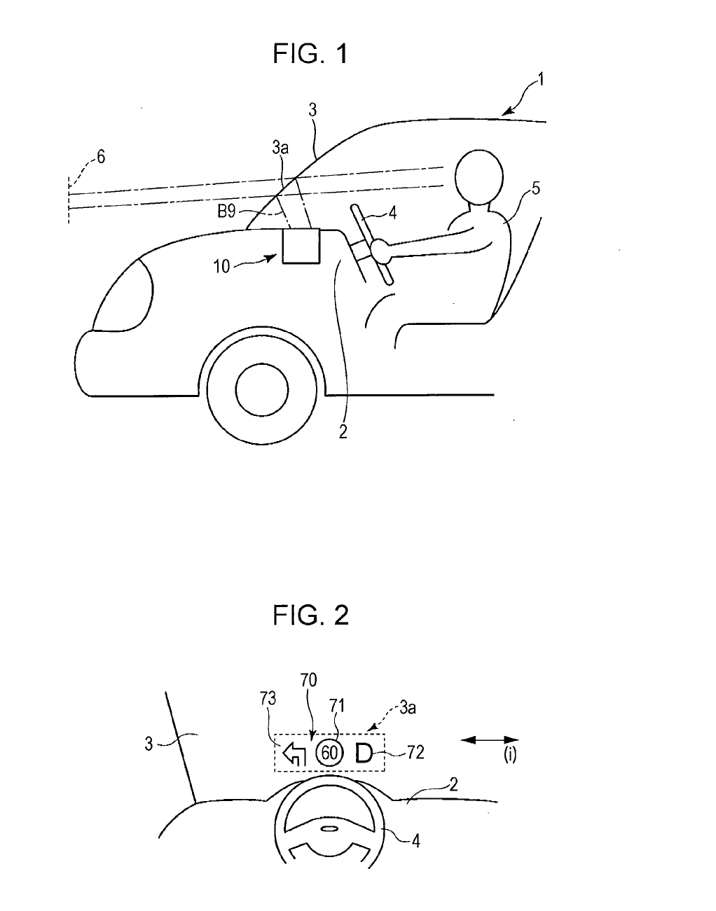

An image processing apparatus 10 according to an embodiment of the present invention is, as illustrated in FIG. 1, used as a so-called head-up display disposed in a dashboard 2 located at a front portion of a cabin of a vehicle 1.

A display image 70 illustrated in FIG. 2 is projected from the image processing apparatus 10 to a display region 3a of a windshield 3. Since the display region 3a functions as a semi-reflective surface, the display image 70 projected onto the display region 3a is reflected at the display region 3a toward a driver 5, and a virtual image 6 is formed at a position in front of the windshield 3. The virtual image 6 in front of the windshield 3 visually appears to the driver 5 as display of various information in front of and above a steering wheel 4.

### General Structure of Image Processing Apparatus 10

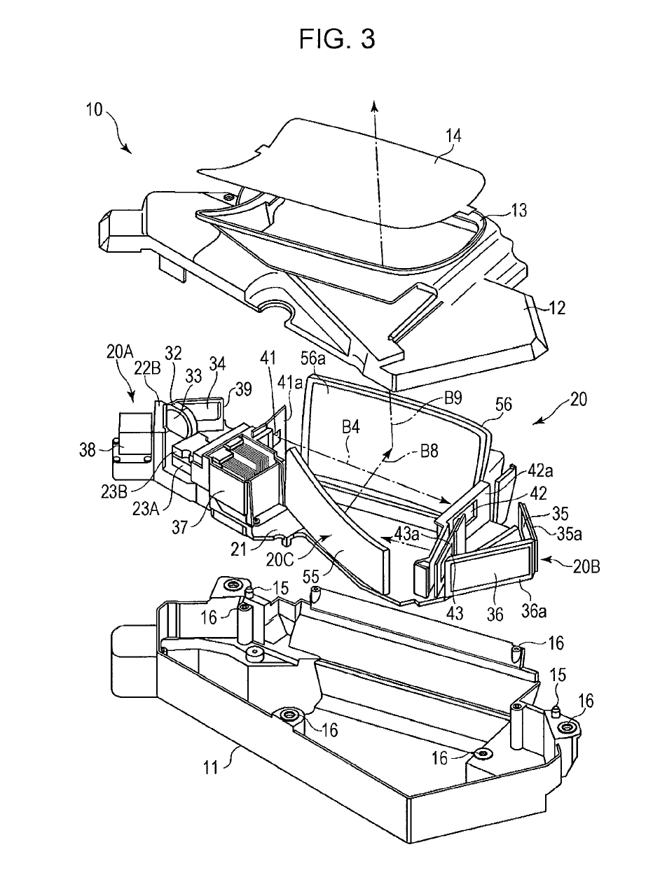

As illustrated in FIG. 3, a casing of the image processing apparatus 10 has a separately prepared lower casing portion 11 and an upper casing portion 12. An optical unit 20 is housed in the casing. The optical unit 20 includes an optical base 21, which is supported through an elastic member such as elastomer or a metal spring in the lower casing portion 11. For example, a support protrusion protruding from a lower surface of the optical base 21 is inserted into a support hole formed in a bottom portion of the lower casing portion 11, and the gap between the support protrusion and the support hole is filled with elastomer.

Although the lower casing portion 11 is secured in the dashboard 2 in the vehicle cabin, vibration of the vehicle 1 can be prevented from directly affecting the optical unit 20 because the optical base 21 is supported through the elastic member. In the case where the lower casing portion 11 and the upper casing portion 12 are formed of a synthetic resin and the optical base 21 is formed of a metal such as aluminum by, for example, die-casting, large stress may act on the optical base 21 because of the difference in thermal expansion coefficient between the lower casing portion 11 and the optical base 21. However, with a support structure using the elastic member, an excessive thermal stress is prevented from acting on the optical base 21 from the lower casing portion 11.

In a state in which the optical unit 20 is disposed in the casing, the lower casing portion 11 and the upper casing portion 12 are positioned relative to each other by protrusion/recess engagement of positioning pins 15, which are integrally formed with the lower casing portion 11. The lower casing portion 11 has a plurality of tapped holes 16. Securing screws inserted through the upper casing portion 12 is screwed into the tapped holes 16, thereby the lower casing portion 11 and the upper casing portion 12 are secured to each other.

The upper casing portion 12 has a projection window 13. The projection window 13 is to be exposed in an upper surface of the dashboard 2. The display image 70 is projected onto the display region 3a of the windshield 3 through the projection window 13. A light-transmissive covering plate 14 is attached to the projection window 13. The covering plate 14 prevents dust from entering the inside of the casing. In order to prevent external light from directly entering through the projection window 13 into the casing, the covering plate 14 preferably uses an optical filter that suppresses transmission of display light of wavelengths other than the wavelengths of a holographic image to be projected onto the display region 3a.

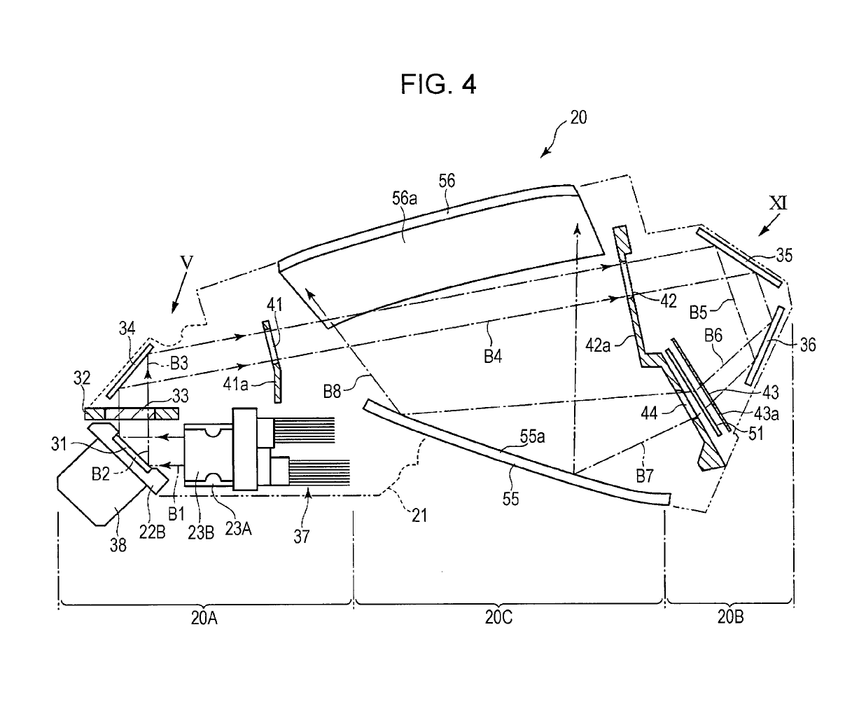

As illustrated in FIGS. 3 and 4, various optical components are mounted on the optical base 21 of the optical unit 20. As illustrated in FIG. 4, the optical unit 20 is divided into a phase modulation unit 20A, a holographic imaging unit 20B, and a projection unit 20C in accordance with the configuration of the optical components.

### Structure of Phase Modulation Unit 20A

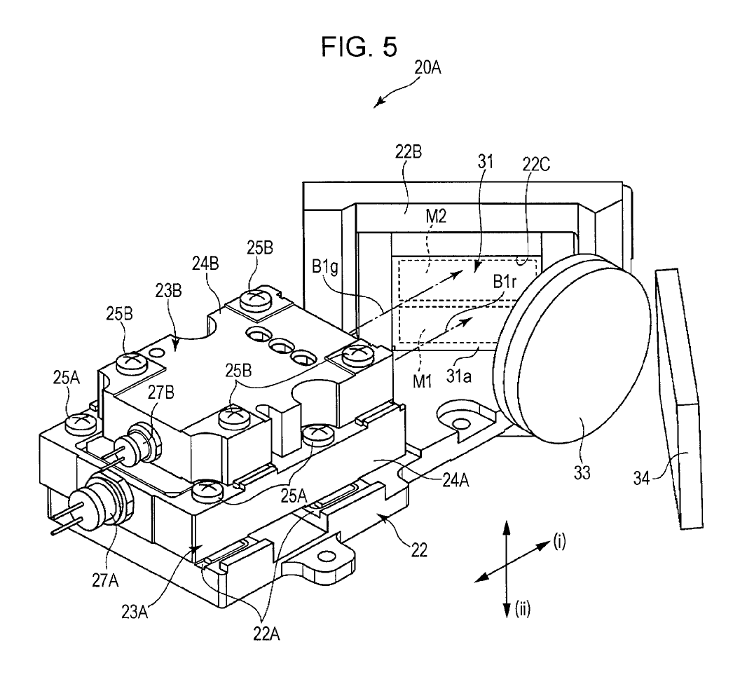

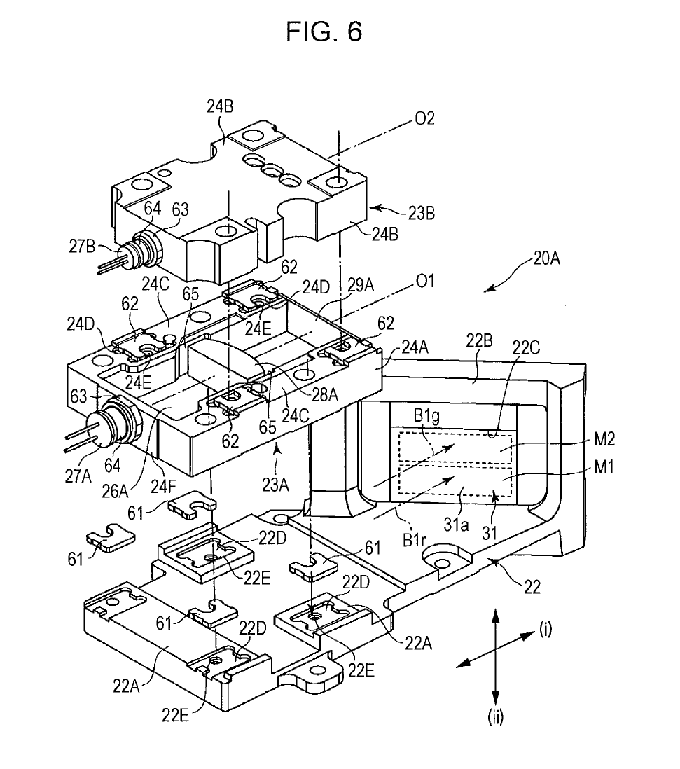

Referring to FIGS. 5 and 6, the phase modulation unit 20A includes a reference base 22, which is secured on the optical base 21 by screws.

A first light emitter 23A and a second light emitter 23B are stacked on the reference base 22. Preferably, the first light emitter 23A includes a first positioning block 24A and the second light emitter 23B includes a second positioning block 24B.

Referring to FIG. 6, a positioning reference surface 22A is formed in an upper surface of the reference base 22. The positioning reference surface 22A has four shallow recesses 22D. Each of the recesses 22D has a bottom portion in which a tapped hole 22E is formed. Preferably, adjustment spacers 61 are provided in the recesses 22D. The first positioning block 24A is disposed on the adjustment spacers 61. As illustrated in FIG. 5, a plurality of securing screws 25A are inserted through the first positioning block 24A and screwed into the tapped holes 22E.

A plurality of types of the adjustment spacers 61 of different thicknesses are prepared. The adjustment spacers 61 are selected and used in accordance with their thicknesses, thereby the level of the first positioning block 24A in the perpendicular direction (ii) is determined. In the case where no adjustment spacer 61 is required for the adjustment the level of the first positioning block 24A, the first positioning block 24A is directly secured to the positioning reference surface 22A.

Referring to FIG. 6, a positioning reference surface 24C is formed in an upper surface of the first positioning block 24A. The positioning reference surface 24C has four shallow recesses 24D. Each of the recesses 24D has a bottom portion in which a tapped hole 24E is formed. Preferably, adjustment spacers 62 are provided in the recesses 24D. The second positioning block 24B is disposed on the adjustment spacers 62. A plurality of securing screws 25B inserted through the second positioning block 24B are screwed into the tapped holes 24E. Out of a plurality of types of the adjustment spacers 62 of different thicknesses, the adjustment spacers 62 of optimum thicknesses are selected, thereby allowing the level of the second positioning block 24B in the perpendicular direction (ii) to be adjusted. In the case where no adjustment spacer 62 is required, the second positioning block 24B is directly secured to the positioning reference surface 24C.

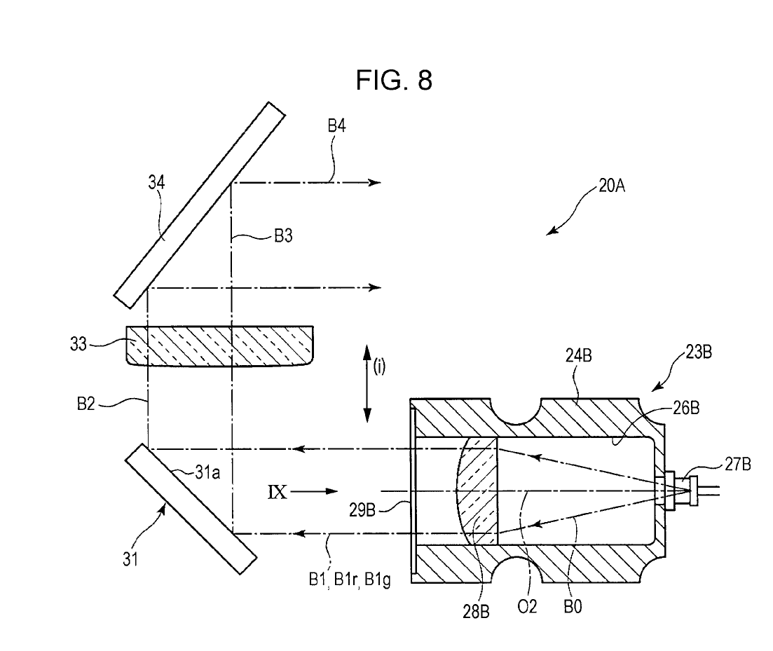

FIG. 6 illustrates an internal structure of the first positioning block 24A. FIG. 8 illustrates an internal structure of the second positioning block 24B.

Referring to FIG. 6, an optical path 26A is formed in the first positioning block 24A. A first laser unit 27A serving as a first laser light source is attached to a closed-side end portion of the optical path 26A (end portion on the left in FIG. 6). The first laser unit 27A includes a metal casing and a semiconductor laser chip housed in the metal casing. A collimating lens 28A is secured in the optical path 26A.

Also, as illustrated in FIG. 8, an optical path 26B is formed in the second positioning block 24B disposed in the second light emitter 23B. A second laser unit 27B serving as a second laser light source is attached to a closed end portion of the optical path 26B. A collimating lens 28B is secured in the optical path 26B.

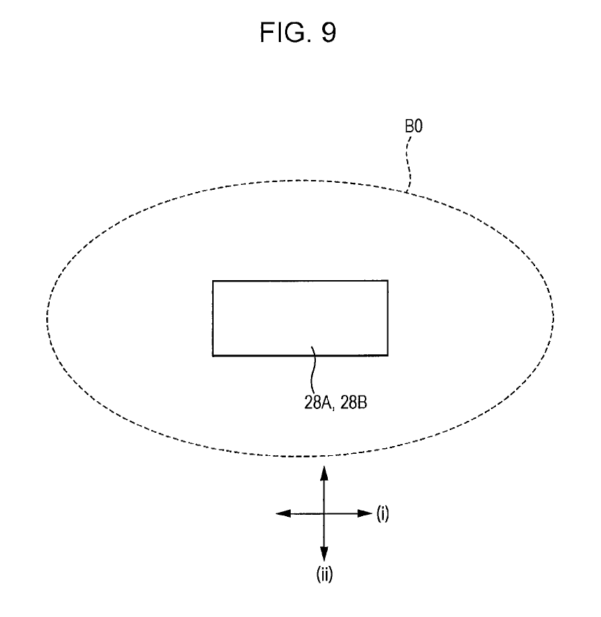

In FIGS. 8 and 9, for convenience of description, a laser beam emitted from the first laser unit 27A and a laser beam emitted from the second laser unit 27B are denoted by the same reference sign B0. The laser beams B0 are divergent beams. As illustrated in FIG. 9, the sectional shape of the laser beams B0 is an ellipse or an oval, the major axis of which extends in a lateral direction (i) parallel to the upper surface of the reference base 22, and the minor axis of which extends in the perpendicular direction (ii) perpendicular to the upper surface of the reference base 22.

As illustrated in FIG. 9, effective diameters (effective areas) of the collimating lenses 28A and 28B are rectangular, and the long sides of the rectangles extend in the lateral direction (i), which is the same as the major axis directions of the sections of the laser beams B0. When the laser beam B0 emitted from the first laser unit 27A passes through the collimating lens 28A, the laser beam B0 is converted into a collimated beam (parallel beam) B1 having a rectangular section. Likewise, when the laser beam B0 emitted from the second laser unit 27B passes through the collimating lens 28B, the laser beam B0 is converted into a collimated beam B1 having a rectangular section.

As illustrated in FIG. 6, an opening end of the optical path 26A of the positioning block 24A is closed by a transparent cover 29A. Likewise, as illustrated in FIG. 8, an opening end of the optical path 26B of the second positioning block 24B is closed by a transparent cover 29B.

Referring to FIG. 9, in each of the laser beams B0 emitted from the laser unit 27A and 27B, the polarization direction of light of the p-wave component may be mainly directed in the minor axis direction. In this case, the transparent cover 29B preferably uses a ½ wave plate. When the ½ wave plate is used, the polarization direction is changed by 90 degrees, and the p-wave components of the collimated beams B1, the polarization direction of which is the lateral direction (i), are increased. As a result, referring to FIG. 2, the polarization direction of the p-wave components is directed in the lateral direction (i) relative to the windshield 3 in the display region 3a. This facilitates semi-reflection of the display image 70 in the display region 3a.

As illustrated in FIGS. 3 and 4, the phase modulation unit 20A includes a heat dissipator/cooler 37. The heat dissipator/cooler 37 dissipates heat generated by the first laser unit 27A and the second laser unit 27B.

The wavelengths of the laser beams emitted from the first laser unit 27A of the first light emitter 23A and the second laser unit 27B of the second light emitter 23B are different from each other. In the image processing apparatus 10 of the present embodiment, the wavelength of the collimated beam B1 emitted from the first light emitter 23A is reddish 642 nm, and the wavelength of the collimated beam B1 emitted from the second light emitter 23B is greenish 515 nm.

Thus, the collimated beam obtained from the first light emitter 23A is denoted by a reference sign B1r, and the collimated beam obtained from the second light emitter 23B is denoted by a reference sign B1g hereafter.

As illustrated in FIG. 5, the reference base 22 has a positioning holding portion 22B integrally formed therewith. The positioning holding portion 22B has a holding frame 22C, in which a phase modulation array 31 is held. The positioning reference surface 22A, which positions the first light emitter 23A and the second light emitter 23B, and the holding frame 22C are integrally formed with the reference base 22. Accordingly, the position of the phase modulation array 31 relative to the first light emitter 23A and the second light emitter 23B is highly accurately determined. Thus, the collimated beams B1r and B1g, which are respectively emitted from the first light emitter 23A and the second light emitter 23B, can be incident upon an optical surface 31a of the phase modulation array 31 at optimum incident angles.

The phase modulation array 31 uses a liquid crystal on silicon (LCOS) panel. The LCOS panel is a reflective panel that includes a liquid crystal layer and an electrode layer formed of a material such as aluminum. In the LCOS panel, electrodes that apply electric fields to the liquid crystal layer are regularly arranged so as to form a plurality of pixels. Changes in the field intensities applied to the electrodes change tilting angles of crystals in the liquid crystal layer in a layer thickness direction. This causes the phase of the reflected laser beam to be changed on a pixel-by-pixel basis.

As illustrated in FIGS. 3 and 4, the phase modulation unit 20A includes the heat dissipator/cooler 37 that dissipates heat generated by the phase modulation array 31.

As illustrated in FIGS. 5 and 6, the collimated beam B1r converted by the collimating lens 28A of the first light emitter 23A is applied to a lower region of the phase modulation array 31, and the collimated beam B1g converted by the collimating lens 28B of the second light emitter 23B is applied to an upper region of the phase modulation array 31. In the phase modulation array 31, the region, to which the collimated beam B1r is applied, is a first conversion region M1 and the region, to which the collimated beam B1g is applied, is a second conversion region M2.

Since the collimated beam B1r and the collimated beam B1g have rectangular sections, the first conversion region M1 and the second conversion region M2 have rectangular shapes. By adjusting the positions of the first light emitter 23A and the second light emitter 23B relative to each other in the perpendicular direction (ii) in the reference base 22, the first conversion region M1 and the second conversion region M2 are set so as not to be superposed with each other.

The phases of light components of the collimated beam B1r applied to the first conversion region M1 are converted when the collimated beam B1r passes through a plurality of pixels of the phase modulation array 31. The phases of light components of the collimated beam B1g applied to the second conversion region M2 are also converted when the collimated beam B1g passes through a plurality of pixels of the phase modulation array 31. Referring to FIG. 8, a modulated beam B2 having been reflected by the phase modulation array 31 is an interfered beam generated by interference of light components of the beams having passed through the pixels with one another. This interfered beam includes interference of light components of the reddish collimated beam B1r with one another, interference of light components of the greenish collimated beam B1g with one another, and interference of the light components of the reddish collimated beam B1r and the light components of the greenish collimated beam B1g with one another.

As illustrated in FIG. 3, the phase modulation unit 20A includes a lens holder 32. The lens holder 32 is positioned and secured on the reference base 22. A Fourier transform (FT) lens 33 is held by the lens holder 32. The modulated beam B2 reflected by the phase modulation array 31 passes through the FT lens 33 and becomes a Fourier transformed modulated beam B3.

As illustrated in FIG. 3, the phase modulation unit 20A includes a light sending mirror 34 held by a mirror holding member 39. The light sending mirror 34 is a plane mirror. The optical axis of the FT lens 33 is incident upon a reflective surface of the light sending mirror 34 at a specified angle. The modulated beam B3 having been Fourier transformed by the FT lens 33 is reflected by the light sending mirror 34, and a reflected modulated beam B4 passes through the optical unit 20 and is sent to the holographic imaging unit 20B.

### Structure of Holographic Imaging Unit 20B

As illustrated in FIG. 3, the holographic imaging unit 20B includes a first intermediate mirror 35 held by a mirror holding member 35a and a second intermediate mirror 36 held by a mirror holding member 36a. The first intermediate mirror 35 and the second intermediate mirror 36 are plane mirrors. As illustrated in FIG. 4, a reflective surface of the first intermediate mirror 35 opposes the reflective surface of the light sending mirror 34 provided in the phase modulation unit 20A. Furthermore, the reflective surfaces of the first intermediate mirror 35 and the second intermediate mirror 36 oppose each other at a specified angle. In the holographic imaging unit 20B, a screen 51 is disposed in a reflecting direction of light reflected by the reflective surface of the second intermediate mirror 36.

As illustrated in FIG. 4, the modulated beam B4 reflected by the light sending mirror 34 travels in the casing rightward in FIG. 4, and then is reflected by the first intermediate mirror 35. A reflected modulated beam B5 is reflected by the second intermediate mirror 36. A modulated beam B6 reflected by the second intermediate mirror 36 is applied to the screen 51.

In the phase modulation array 31, the phases of the light components of the reddish laser beam are converted by the pixels of the first conversion region M1 and the phases of the light components of the greenish laser beam are converted by the pixels of the second conversion region M2. The light in which the reddish and greenish interfered light components are mixed is Fourier converted by the FT lens 33, and images of the modulated beams B3, B4, B5, and B6 are formed in a defocused state on the screen 51 through the optical path in the casing. Thus, a holographic image is formed on the screen 51.

When the interfered beam having passed through the phase modulation array 31 is condensed through the FT lens 33, an image of first-order diffraction light is formed on the screen 51. The holographic image of the substantially the same content as that of the display image 70 projected onto the display region 3a illustrated in FIG. 2 is formed on the screen 51. This holographic image is formed of reddish, greenish, and a color produced by combining these two hues. Since the modulated beams B3, B4, B5, and B6 include interfered light components, many stray light images generated by second-order diffraction light, third-order diffraction light, and the like exist in a space between the phase modulation array 31 and the screen 51. Thus, a plurality of apertures are formed in the optical path between the phase modulation array 31 and the screen 51 so that only the first-order diffraction light can reach the screen 51.

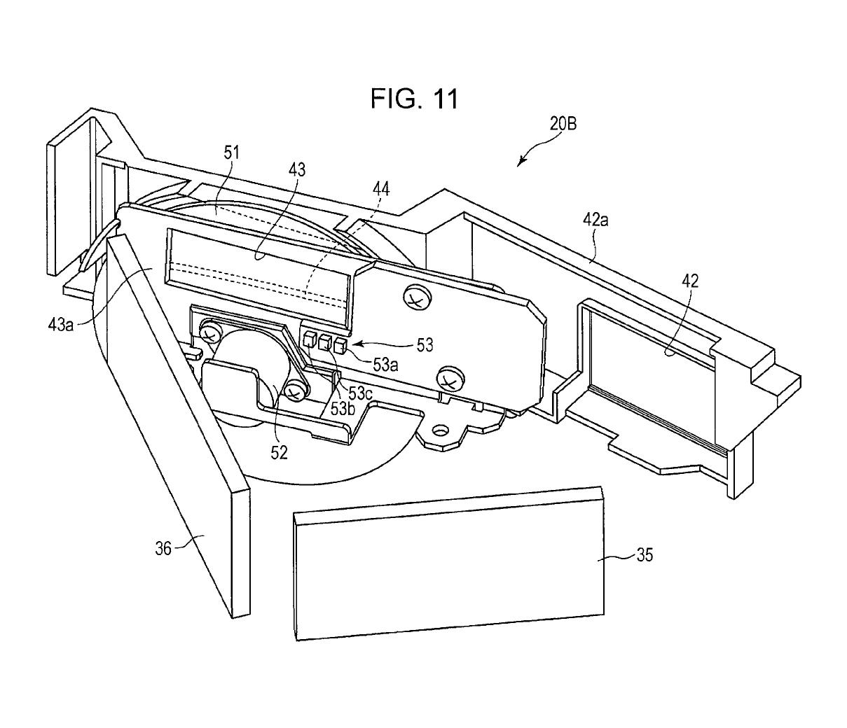

As illustrated in FIGS. 3 and 4, a shading wall 41a is provided in a light exiting portion of the phase modulation unit 20A. The shading wall 41a has a rectangular first aperture 41. A shading wall 42a is provided in a light entrance portion of the holographic imaging unit 20B. The shading wall 42a has a rectangular second aperture 42. A shading wall 43a is provided between the second intermediate mirror 36 and the screen 51. The shading wall 43a has a rectangular third aperture 43. The third aperture 43 is also illustrated in FIG. 11.

With three apertures 41, 42, and 43 provided in the optical path through which the modulated beam reflected by the light sending mirror 34 reaches the screen 51, the stray light other than the first-order diffraction light is blocked, and only the first-order diffraction light that forms a holographic image can reach the screen 51.

As illustrated in FIG. 11, the screen 51 is disposed ahead of (on the light exit side of) the third aperture 43 in the holographic imaging unit 20B. The modulated beam B6 reflected by the second intermediate mirror 36 passes through the third aperture 43 and reaches the screen 51. Thus, a holographic image of the first-order diffraction light is generated on the screen 51. The screen 51 uses a transparent diffuser having a surface, in which fine irregularities are formed. The light including the holographic image formed on the screen 51 is transmitted through the screen 51 and becomes a divergent projection beam B7. As illustrated in FIG. 4, the projection beam B7 passes through a fourth aperture 44 formed in the shading wall 42a and is applied to the projection unit 20C.

As illustrated in FIG. 11, a motor 52 is secured to the shading wall 43a having the third aperture 43 in the holographic imaging unit 20B. The disc-shaped screen 51 is constantly rotated by the power of the motor 52. By rotating the screen 51, speckle noise, which may cause flicker of the display image 70, can be reduced.

As illustrated in FIG. 11, a monitor detector 53 is provided on the shading wall 43a in the holographic imaging unit 20B. The monitor detector 53 is disposed below the third aperture 43. The monitor detector 53 includes the following three detectors: a red wavelength detector 53a, a green wavelength detector 53b, and a position detector 53c. In each of the detectors 53a, 53b, and 53c, a light receiving element such as a positive-intrinsic-negative (PIN) photodiode is housed in a closed space and an opening is formed on a side opposing the second intermediate mirror 36. In the red wavelength detector 53a, the opening is covered by a wavelength filter that allows red light to transmit therethrough. In the green wavelength detector 53b, the opening is covered by a wavelength filter that allows green light to transmit therethrough.

Each of the detectors 53a, 53b, and 53c is irradiated with either of the first-order diffraction light or multiple-order diffraction light other than the first-order diffraction light. The positions of the first light emitter 23A, the second light emitter 23B, and other optical components are adjusted in accordance with detection output of the position detector 53c. Emission intensities of the first laser unit 27A and the second laser unit 27B are automatically adjusted in accordance with detection output of the red wavelength detector 53a and the green wavelength detector 53b. Also, the phase modulation array 31 is controlled so that the image of the first-order diffraction light can be formed on a projection surface 51a of the screen 51.

### Structure of Projection Unit 20C

As illustrated in FIGS. 3 and 4, the projection unit 20C includes a first projecting mirror 55 and a second projecting mirror 56, which oppose each other. A reflective surface 55a of the first projecting mirror 55 and a reflective surface 56a of the second projecting mirror 56 are concave mirrors (magnifiers). The projection beam B7 that includes the holographic image formed on the screen 51 is diverged by the screen 51 and applied to the first projecting mirror 55. A projection beam B8, in which the holographic image has been enlarged by the first projecting mirror 55, is applied to the second projecting mirror 56 so as to further enlarge the holographic image. As illustrated in FIG. 3, a projection beam B9 reflected by the reflective surface 56a of the second projecting mirror 56 is directed upward, transmitted through the covering plate 14, and is projected onto the display region 3a of the windshield 3 as illustrated in FIG. 1.

As illustrated in FIG. 2, various information related to running of the vehicle such as a vehicle speed display 71, gear position information 72, and navigation information 73 are displayed in the display image 70. The display image 70 is displayed by red light, green light, or light of a color produced by combining red and green.

Since the windshield 3 functions as semi-reflective surface, the display image 70 appears to the driver 5 as an image existing at an image formation position of the virtual image 6 in front of the windshield 3.

Since the holographic image formed on the screen 51 is enlarged and projected onto the display region 3a in the image processing apparatus 10, even when the inside of the covering plate 14 is seen from the outside of the windshield 3, the laser beam is not directly applied to human eyes, thereby safety is ensured.

### Adjustment of Phase Modulation Unit 20A

In the phase modulation array 31, a region to be irradiated with the collimated beam B1r emitted from the first light emitter 23A is the first conversion region M1, and a region to be irradiated with the collimated beam B1g emitted from the second light emitter 23B is the second conversion region M2. When the first conversion region M1 and the second conversion region M2 are formed, it is required that the first conversion region M1 and the second conversion region M2 be highly accurately positioned at a predetermined regions of the phase modulation array 31. In the case where the regions of the first conversion region M1 and the second conversion region M2 are incorrectly set, it is unlikely that the holographic image is correctly formed on the screen 51. Furthermore, in the case where the relative positions between the lenses are not highly accurately determined, the holographic image cannot be clearly formed on the screen 51.

In order to suppress the above-described problems, the following adjustment is performed when assembling the phase modulation unit 20A.

### (1) Adjustment of Securing Positions of Laser Units 27A and 27B Relative to Positioning Blocks 24A and 24B

As illustrated in FIG. 6, a specified optical axis O1 is determined in the design in the first positioning block 24A for this block as a single component. Likewise, a specified optical axis O2 is determined in the design in the second positioning block 24B.

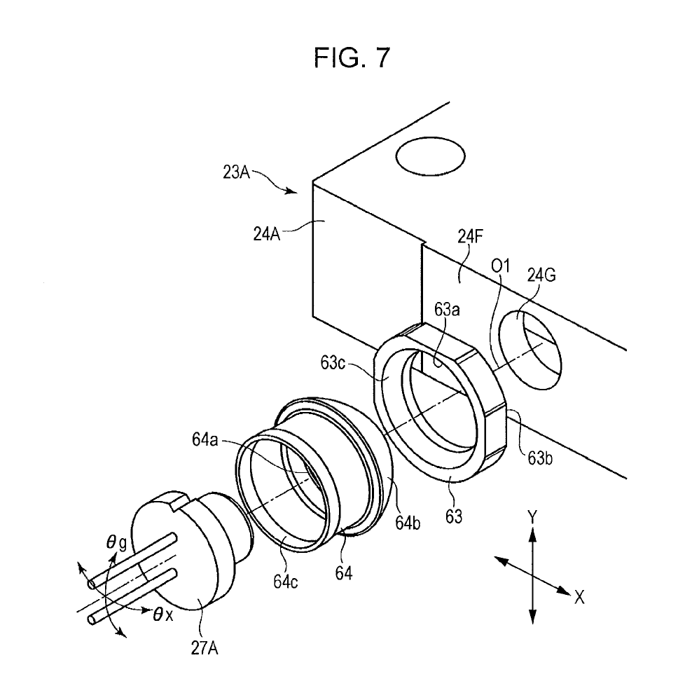

As illustrated in FIG. 7, an attachment surface 24F is formed in an end surface of the first positioning block 24A, and a light sending hole 24G is formed in the attachment surface 24F. The light sending hole 24G communicates with the optical path 26A. The specified optical axis O1 extends through the center of the light sending hole 24G. The attachment surface 24F is a flat surface perpendicular to the specified optical axis O1.

Preferably, the first laser unit 27A is secured to the attachment surface 24F by using a first positioning member 63 and a second positioning member 64. The first positioning member 63 is a ring member having a through hole 63a at the center thereof. A securing surface 63b of the first positioning member 63 opposite the attachment surface 24F is a flat surface. The first positioning member 63 has a receiving recessed surface 63c around the through hole 63a on a side thereof opposite to the securing surface 63b.

The second positioning member 64 is a cylindrical bracket having a through hole 64a at the center thereof. A surface of the second positioning member 64 opposite the first positioning member 63 is an abutting surface 64b. Both of the receiving recessed surface 63c of the first positioning member 63 and the abutting surface 64b of the second positioning member 64 are parts of respective spherical surfaces. The radius of curvature of the spherical surface of the receiving recessed surface 63c is coincident with the radius of curvature of the spherical surface of the abutting surface 64b. Alternatively, the radius of curvature of the receiving recessed surface 63c is slightly smaller than the radius of curvature of the abutting surface 64b. The second positioning member 64 has a holding cylinder 64c integrally formed therewith on a side opposite to the abutting surface 64b.

The first positioning block 24A, the first positioning member 63, and the second positioning member 64 are formed of metal such as stainless steel. A casing of the first laser unit 27A is also formed of stainless steel. The casing of the first laser unit 27A is inserted into the holding cylinder 64c of the second positioning member 64 and secured to the holding cylinder 64c by laser welding. With the first laser unit 27A secured to the second positioning member 64, a laser emitting point of the first laser unit 27A is coincident with the substantial center of the radius of curvature of the abutting surface 64b.

When assembling the first light emitter 23A, the first positioning block 24A that holds the collimating lens 28A is secured to a jig of an optical adjustment device. The optical adjustment device includes an FT lens in front of the first positioning block 24A, which is held by the jig, and a beam profiler. Before the assembly and adjustment of the first light emitter 23A, a reference laser is disposed in the optical adjustment device, and an ideal optical pattern is read by the beam profiler and stored in memory.

With the first positioning block 24A secured to the jig, the second positioning member 64, to which the first laser unit 27A has been secured, and the first positioning member 63 are combined with each other, and the resultant combination is caused to abut the attachment surface 24F. Preferably, while emitting the laser beam by energizing the first laser unit 27A, the second positioning member 64 and the first positioning member 63 are moved in the X-Y directions along the attachment surface 24F, and the beam profiler is referred to so as to make an adjustment for aligning the light emitting point of the first laser unit 27A with the specified optical axis O1.

After that, preferably, the abutting surface 64b of the second positioning member 64 is slid relative to the receiving recessed surface 63c of the first positioning member 63 in the θx and θy directions so as to adjust a tilt of the first laser unit 27A, while the beam profiler is referred to. Thus, the tilt of an emission optical axis of the laser beam from the first laser unit 27A relative to the specified optical axis O1 is adjusted to zero.

When the positions of the first positioning member 63 and the second positioning member 64 have been adjusted, the first positioning member 63 and the attachment surface 24F are secured to each other by laser welding, and the first positioning member 63 and the second positioning member 64 are secured to each other by laser welding.

Likewise, in the second light emitter 23B, the position of the second laser unit 27B relative to the second positioning block 24B is adjusted by the first positioning member 63 and the second positioning member 64, and the second laser unit 27B is secured to the second positioning block 24B.

### (2) Adjustment of Positions of Collimating Lenses 28A and 28B

As illustrated in FIG. 6, the collimating lens 28A provided in the first light emitter 23A has a rectangular shape. Preferably, the optical path 26A formed in the first positioning block 24A has recesses in left and right walls thereof, and holding and sliding flat surfaces 65 are formed at bottoms of the recesses so as to oppose each other. The width of the collimating lens 28A is substantially coincident with the distance by which the opposing holding and sliding flat surfaces 65 are separated from each other. This allows the collimating lens 28A inserted between the holding and sliding flat surfaces 65 to translate back and force along the specified optical axis O1 with little tilt.

After the first positioning block 24A has been secured to the jig of the optical adjustment device and the positions of the first positioning member 63, the second positioning member 64, and the first laser unit 27A have been adjusted and secured, the position of the collimating lens 28A is adjusted while the first positioning block 24A is still secured to the jig.

In this positional adjustment, the collimating lens 28A is held by a suction jig. As the suction jig is moved, the collimating lens 28A is moved back and forth along the specified optical axis O1 in the optical path 26A. The beam profiler is referred to, and when a distribution of the light intensity measured by the beam profiler becomes close to the optimum, the collimating lens 28A is secured to the first positioning block 24A by a ultra-violet (UV) curable adhesive.

Similar adjustment is performed in the second light emitter 23B so that the position of the collimating lens 28B is adjusted and secured in the second positioning block 24B.

### (3) Combining and Adjustment of First Light Emitter 23A and Second Light Emitter 23B

As described above in the adjustment steps (1) and (2), the first light emitter 23A and the second light emitter 23B are separately adjusted and assembled as single units. After that, the first light emitter 23A and the second light emitter 23B are attached to the reference base 22.

When attaching the first light emitter 23A and the second light emitter 23B to the optical unit 20, as illustrated in FIG. 6, the first positioning block 24A is preferably disposed on the positioning reference surface 22A of the reference base 22 with the adjustment spacers 61 interposed therebetween. With the first positioning block 24A temporarily secured by the securing screws 25A, the first laser unit 27A is caused to emit light so as to radiate the collimated beam B1r toward the phase modulation array 31. Preferably, the first conversion region M1, which is irradiated with the collimated beam B1r, is observed by a measurement camera. Preferably, the adjustment spacers 61 are selected so that the first conversion region M1 is at a predetermined level.

Next, the second positioning block 24B is preferably disposed on the first positioning block 24A. Also at this time, preferably, by selecting the adjustment spacers 62, the height position of the second light emitter 23B in the perpendicular direction (ii) is adjusted. Preferably, the adjustment is checked by causing the second laser unit 27B to emit light, forming the second conversion region M2 in the phase modulation array 31, and observing the second conversion region M2 by a camera.

After the levels, at which the first positioning block 24A and the second positioning block 24B are disposed, have been determined, preferably, radiation angles of the collimated beams B1r and B1g emitted from the first and second positioning blocks 24A and 24B in the lateral direction are adjusted.

After the above-described level adjustment has been performed, without completely tightening the securing screws 25A and 25B, the laser radiation directions are changed by laterally moving the first positioning block 24A and the second positioning block 24B within respective movable ranges allowed by the gaps between the securing screws 25A and 25B and the securing holes. This adjustment is made while observing with the camera the region of the phase modulation array 31 irradiated with the reddish collimated beam B1r (first conversion region M1) and the region of the phase modulation array 31 irradiated with the greenish collimated beam B1g (second conversion region M2). Alternatively, the adjustment is made while observing the position, hues, and sharpness of the holographic image as follows: the first laser unit 27A and the second laser unit 27B are caused to emit light by drive signals based on display data of the display image 70; the holographic image is actually formed on the screen 51; and the holographic image is picked up by the camera.

Preferably, when the first positioning block 24A and the second positioning block 24B have been appropriately oriented, the securing screws 25A and 25B are tightened, thereby the first positioning block 24A and the second positioning block 24B are secured.

### (4) Mirror Adjustment

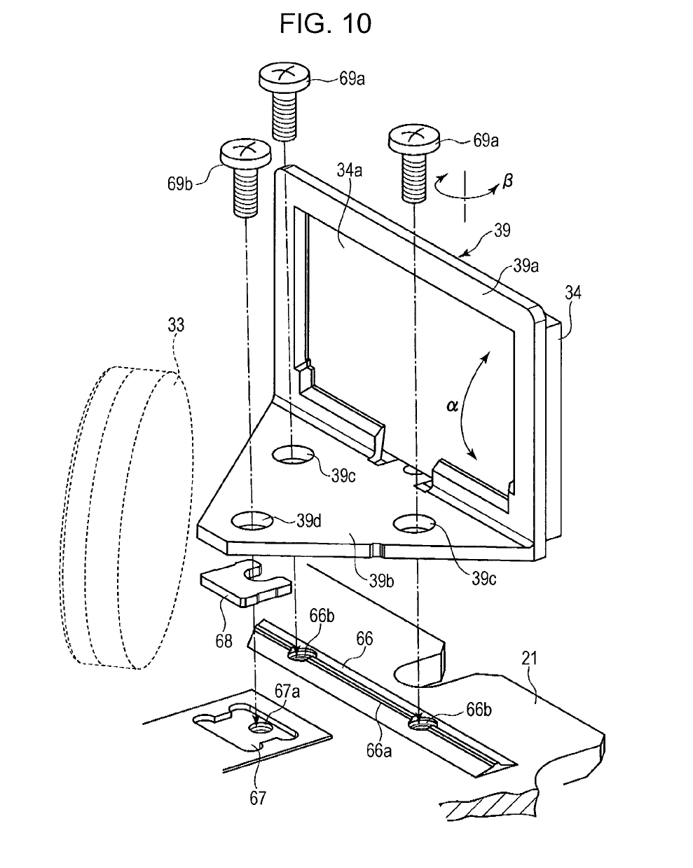

FIG. 10 illustrates a support structure of the light sending mirror 34 provided in the phase modulation unit 20A. The mirror holding member 39 is formed of aluminum by die-casting and has a holding frame 39a and a support portion 39b integrally formed therewith. The holding frame 39a and the support portion 39b are perpendicular to each other.

A support member (not illustrated), which is formed of a flat spring material, is secured to a rear portion of the holding frame 39a. The light sending mirror 34 is elastically pinched between the holding frame 39a and the support member. The support portion 39b has a triangular shape. In the support portion 39b, a pair of support securing holes 39c are formed at positions near the holding frame 39a and an adjustment securing hole 39d is formed at a position away from the holding frame 39a. The positional relationships between the pair of support securing holes 39c and the adjustment securing hole 39d are such that the support securing holes 39c and the adjustment securing hole 39d are disposed at respective vertices of a triangle.

As illustrated in FIG. 10, at a lateral side of the FT lens 33, a rib 66 is integrally formed with the optical base 21 on an upper surface of the optical base 21. The rib 66 has a narrow support protrusion 66a at the top thereof. The support protrusion 66a is parallel to the design position of a reflective surface 34a of the light sending mirror 34. The rib 66 also has a pair of support tapped holes 66b therein. The support tapped holes 66b penetrate through the support protrusion 66a.

The optical base 21 has a shallow recess 67, in which an adjustment securing tapped hole 67a is formed. The positional relationships between the pair of support tapped holes 66b and the adjustment securing tapped hole 67a are such that the support tapped holes 66b and the adjustment securing tapped hole 67a are disposed at respective vertices of a triangle.

Support securing screws 69a are inserted through the pair of support securing holes 39c formed in the support portion 39b and screwed into the support tapped holes 66b. An adjustment spacer 68 is disposed in the recess 67, an adjustment securing screw 69b is inserted through the adjustment securing hole 39d and screwed into the adjustment securing tapped hole 67a.

A plurality of types of the adjustment spacers 68 of different thicknesses are prepared. The adjustment spacer 68 to use is selected from among these adjustment spacers 68 to adjust the angle of the light sending mirror 34 in a tilting direction (α direction). When the support portion 39b is secured by the support securing screws 69a and the adjustment securing screw 69b, the support portion 39b can be tilted while supported at the narrow support protrusion 66a. Thus, the support portion 39b can be firmly secured to the optical base 21 regardless of the thickness of the adjustment spacer 68.

At the same time as the tilt of the light sending mirror 34 in the α direction is adjusted or after the tilt of the light sending mirror 34 in the α direction has been adjusted, without completely tightening three securing screws 69a, and 69b, the tilting angle in the β direction is adjusted by moving the mirror holding member 39 in the rotational direction (β direction) within movable ranges allowed by the gaps between the securing screws 69a and 69b and the securing holes 39c and 39d. When the angles in the α and β directions have been adjusted, the securing screws 69a and 69b are tightened and the mirror holding member 39 is secured to the optical base 21.

The shape of the mirror holding member 35a, which holds the first intermediate mirror 35 provided in the holographic imaging unit 20B, is substantially the same as that of the mirror holding member 39 illustrated in FIG. 10. The same support structure as illustrated in FIG. 10 is formed below the mirror holding member 35a, and accordingly, the angles of the first intermediate mirror 35 in the α and β directions are also adjustable.

While the holographic image is formed on the screen 51 by causing the laser unit 27A and the laser unit 27B of the first light emitter 23A and the second light emitter 23B to emit light, the angles of the light sending mirror 34 and the first intermediate mirror 35 are adjusted, so that the image formation position of the holographic image in the screen 51 is adjusted to be in a specified region.

### Description of Optical Path in Casing

When the image processing apparatus 10 is installed in the vehicle, the optical base 21 of the optical unit 20 is in the substantially lateral position. As illustrated in FIG. 4, the optical axes of the following beams laterally extend so as to be parallel to the optical base 21: the collimated beams B1r and B1g emitted from the first light emitter 23A and the second light emitter 23B; the modulated beam B2 converted by the phase modulation array 31; and the modulated beam B3 having passed through the FT lens. Furthermore, the optical axes of the following beams also laterally extend so as to be parallel to the optical base 21: the modulated beam B4 reflected by the light sending mirror 34, the modulated beam B5 reflected by the first intermediate mirror 35, and the modulated beam B6 reflected by the second intermediate mirror 36. The optical axis of the projection beam B7 having passed through the screen 51 also laterally extends. The projection beam B8 reflected by the first projecting mirror 55 is slightly upwardly directed and applied to the second projecting mirror 56. The upwardly directed projection beam B9 reflected by the second projecting mirror 56 is radiated toward the windshield 3.

The beams of the light components except for the projection beams B8 and B9 are substantially laterally directed so as to intersect the upward projecting direction of the projection beam B9. Thus, the image processing apparatus 10 can have a thin structure. This facilitates installation of the image processing apparatus 10 in the dashboard 2.

As illustrated in FIGS. 3 and 4, the modulated beam B4 from the light sending mirror 34 to the first intermediate mirror 35 passes through a space between the first projecting mirror 55 and the second projecting mirror 56. The projection beam B8 traveling from the first projecting mirror 55 toward the second projecting mirror 56 intersects the modulated beam B4. By causing the beams to intersect each other in the projection unit 20C, the length of the optical path from the FT lens 33 to the screen 51 can be increased. Thus, the holographic image can be formed on the screen 51 at an appropriate magnification. Furthermore, by causing the beams to intersect each other, the size of the image processing apparatus 10 can be reduced even when the length of the optical path is long.

As illustrated in FIG. 4, traveling directions of the modulated beam B4, which travels from the light sending mirror 34 to the first intermediate mirror 35, and the modulated beam B6, which travels from the second intermediate mirror 36 to the screen 51, are opposite to each other. Also, a traveling direction of the projection beam B7, which travels from the screen 51 to the first projecting mirror 55, is opposite to that of the modulated beam B4. Also by inverting the traveling directions of the beams in the casing as described above, the overall size of the apparatus can be reduced.

What is claimed is:

1. An image processing apparatus comprising:
a laser unit;
a collimating lens that converts a laser beam emitted from the laser unit into a collimated beam;
a phase modulation array that modulates a phase of the collimated beam to generate a holographic image; and
a positioning block,
wherein the laser unit is positioned at and secured to the positioning block,
wherein the positioning block has an optical path that allows the laser beam emitted from the laser unit to pass therethrough, and
wherein a position of the collimating lens in an optical axis direction is adjusted and the collimating lens is secured in the optical path.

2. The image processing apparatus according to claim 1,
wherein the optical path has walls that oppose each other, and the walls have respective holding and sliding flat surfaces spaced apart from and oppose each other, and
wherein the position of the collimating lens is adjusted in the optical axis direction and the collimating lens is secured while the collimating lens is pinched between the holding and sliding flat surfaces that oppose each other.

3. The image processing apparatus according to claim 1, further comprising:
a first positioning member and a second positioning member that secure the laser unit to an attachment surface of the positioning block,
wherein the first positioning member abuts the attachment surface and secured to the attachment surface after a position of the first positioning member has been adjusted in a plane perpendicular to a specified optical axis set in the positioning block, and
wherein the laser unit is held by the second positioning member, and the second positioning member is secured to the first positioning member after a tilt of a radiation direction of the laser beam has been adjusted relative to the first positioning member.

4. The image processing apparatus according to claim 1, further comprising:
a reference base,
wherein a plurality of the positioning blocks are provided, the plurality of positioning blocks including a first positioning block and a second positioning block,
wherein a plurality of the laser units are provided,
wherein a plurality of the collimating lenses are provided,
wherein the plurality of the positioning blocks support the respective laser units and the respective collimating lenses,
wherein the first positioning block is disposed on and secured to a first positioning reference surface formed on the reference base, a second positioning reference surface is formed on the first positioning block, and the second positioning block is disposed on and secured to the second positioning reference surface, and
wherein the laser beam emitted from each of the laser units supported by a corresponding one of the first positioning block and the second positioning block is radiated toward the phase modulation array.

5. The image processing apparatus according to claim 4, further comprising:
a first adjustment spacer and a second adjustment spacer,
wherein the first adjustment spacer is interposed between the reference base and the first positioning block, and the first positioning block is secured after a level thereof has been adjusted, and
wherein the second adjustment spacer is interposed between the first positioning block and the second positioning block, and the second positioning block is secured after a level thereof has been adjusted.

6. A method of assembling an image processing apparatus, the image processing apparatus including a laser unit, a collimating lens that converts a laser beam emitted from the laser unit into a collimated beam, a phase modulation array that modulates a phase of the collimated beam to generate a holographic image, and a positioning block, the method comprising:
adjusting a position of the laser unit relative to the positioning block and securing the laser unit; and
adjusting a position of the collimating lens in an optical axis direction and securing the collimating lens in an optical path formed in the positioning block.

7. The method according to claim 6,
wherein, in the adjusting of the position of the laser unit and securing of the laser unit, a position of a light emitting point of the laser unit is adjusted, and after that, a tilt of the laser beam emitted from the laser unit is adjusted and the laser unit is secured to the positioning block.

8. The method according to claim 6, comprising:
providing a reference base,
providing a plurality of the positioning, the plurality of positioning blocks including a first positioning block and a second positioning block,
providing a plurality of the laser units,
providing a plurality of the collimating lenses,
positioning the laser units at and secured to the respective positioning blocks, and positioning the collimating lenses at and secured to the respective positioning blocks,
wherein the first positioning block, to which one of the laser units is secured, is disposed on a first positioning reference surface of the reference base, and the second positioning block, to which another of the laser units is secured, is disposed on a second positioning reference surface formed on an upper surface of the first positioning block, and
wherein positions of the first positioning block and the second positioning block are adjusted so that the laser beams emitted from the laser units, which are each supported by a corresponding one of the first positioning block and the second positioning block, are radiated to respective specified regions of the phase modulation array, and
securing the first positioning block and the second positioning block.

9. The method according to claim 8,
providing a first adjustment spacer and a second adjustment spacer,
wherein, when the first positioning block and the second positioning block are disposed, adjusting a level of the first positioning block by interposing the first adjustment spacer between the reference base and the first positioning block, and adjusting a level of the second positioning block by interposing the second adjustment spacer between the first positioning block and the second positioning block.
